(19) United States
(12) Patent Application Publication
(10) Pub. No.: US 2008/0229186 A1
(43) Pub. Date: Sep. 18, 2008

(54) Persisting digital ink annotations as image metadata

(75) Inventors: Gavin M. Gear, Redmond, WA (US); Sam J. George, Duvall, WA (US); Richard L. Spencer, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/724,106

(22) Filed: Mar. 14, 2007

(51) Int. Cl. G06F 17/00; G06F 7/00

(52) U.S. Cl. 715/233; 715/230; 707/100

(57) ABSTRACT

Techniques are described for storing data about a displayed image. Image data corresponding to the displayed image is received. One or more ink annotations associated with the displayed image are received. The image data is stored to a first portion of the image file. A representation of the ink annotations are stored in a second portion of the image file.

### BACKGROUND

An application, such as an image editor used in connection with editing digital photographs, may allow a user to make ink annotations on a displayed image. An ink annotation may be the result of a user drawing on a screen of a tablet computer, digitizer pad, or other device for handwriting or drawing over a displayed image. Using a first technique, some existing applications may store the annotations as part of the image data by converting the ink annotations to image data and modifying the original image data to include the annotations along with the original image data. Thus, the original image data is not preserved and can only be retrieved with the annotations. Other existing applications may use a second technique in which the annotations are stored in a separate file different from the file including the original image data. Using this latter approach, the original image data may be preserved but the application includes code for managing and maintaining both the file with the image data and the second file including the ink annotations. With this latter approach, although the original image data is preserved, one of the files may be separated from the other and both of the files are needed in order to display the image with ink annotations.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are described herein for use in connection with an image file. A representation of ink annotations may be stored within the image file separately from the image data. The representation of the ink annotations may be stored in the metadata portion of the image file. The ink annotations, as represented in the metadata portion, may be processed independently of the image data.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a device for use in connection with performing the techniques described herein;

FIG. 3 is an example block diagram illustrating data flow between components that may be included in an embodiment performing the techniques herein;

FIGS. 4-6 are flowcharts of processing steps that may be performed in an embodiment in connection with the techniques herein;

FIG. 7 is an example illustrating use of the techniques herein for converting from a source format with ink annotations stored as metadata to a target format with ink annotations stored as metadata; and

FIG. 8 is an example illustrating an interface displaying an image for use with the techniques herein.

### DETAILED DESCRIPTION

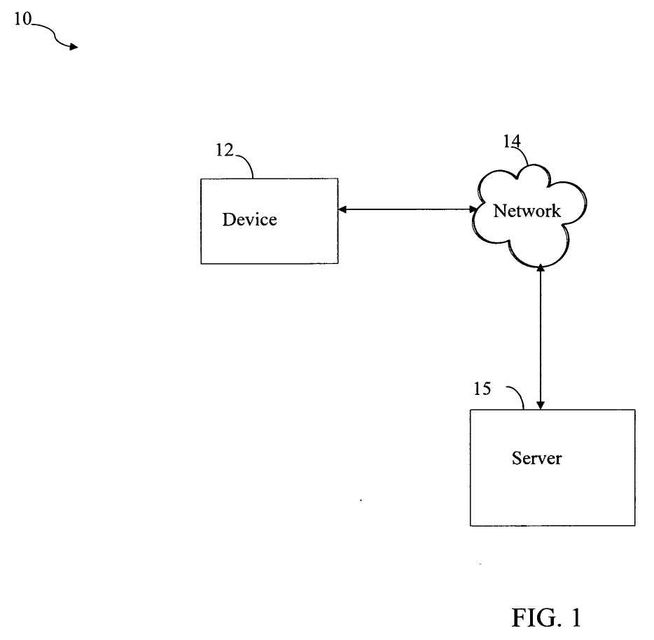

Referring now to FIG. 1, illustrated is an example of a suitable computing environment in which embodiments utilizing the techniques described herein may be implemented. The computing environment illustrated in FIG. I is only one example of a suitable computing environment and is not intended to suggest any limitation as to the scope of use or functionality of the techniques described herein in connection with persisting digital ink annotations as image file metadata. An image may be represented in any one of a variety of different image file formats as described in more detail herein. An image file format may include a first portion with the image data, such as a bitmap or other data representing the image. An image file format may also include one or more other portions, such as a metadata portion for storing metadata therein about the image. Metadata is information about an image, for example, a title, image width or other dimensions, author, and the like. Using techniques described in following paragraphs, ink annotations may be represented and stored in the metadata portion of an image file. The foregoing of storing the ink annotations as image file metadata is in contrast to existing implementations which may either store the ink annotations in a second separate file or represent ink annotations as modifications to the image data so that the original image data is not preserved.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

Included in FIG. 1 are a device 12, a network 14, and a server 15. The device 12 may be, for example, a computer, such as a personal computer, having a display output device and an input device providing for interactive I/O with a user thereof. In following paragraphs, additional details are provided with respect to the device 12. However, the same details may also apply to one or more other devices that may be connected to the network 14 in an embodiment. Although the example 10 of FIG. 1 includes only a single device and a single server, an embodiment utilizing the techniques herein may include any number of devices and other components.

The device 12 included in FIG. 1 is exemplary for purposes of illustrating the techniques described herein in connection with software components. In one embodiment, any device 12 providing the functionality described herein may be included in an embodiment. The device 12 may include a processor used to execute code included in one or more program modules. Described in more detail elsewhere herein are program modules that may be executed by the device 12 in connection with the techniques described herein. The device 12 may operate in a networked environment and communicate with the server 15 and other computers or components not shown in FIG. 1. As described herein, the device 12 may be a personal computer. In other embodiments, the functionality of device 12, or the device 12 itself, may be included in another component in accordance with a particular environment in which the device 12 is utilized.

The server 15 may communicate with device 12 when connected to the network 14. The server 15 may include one or more applications and associated data for use in connection with communications to device 12.

It will be appreciated by those skilled in the art that although the device 12 is shown in the example as communicating in a networked environment, the device 12 may communicate with other components utilizing different communication mediums. For example, the device 12 may communicate with one or more components utilizing a network connection, and/or other type of link known in the art including, but not limited to, the Internet, an intranet, or other wireless and/or hardwired connection(s) to the server 15 and/or other components.

It should also be noted that although the device 12 is illustrated as having network connectivity to the server 15, the techniques described herein may be used in connection with a device directly connected to the server 15 without a network. The device 12 may also operate standalone without external connectivity to the network and server.

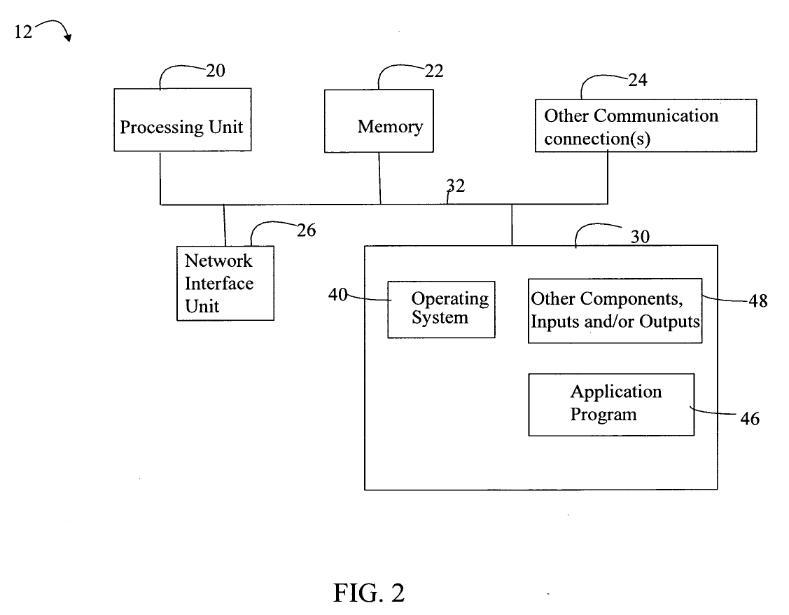

Referring now to FIG. 2, shown is an example of components that may be included in the device 12 as may be used in connection with performing the various embodiments of the techniques described herein. The device 12 may include one or more processing units 20, memory 22, a network interface unit 26, storage 30, one or more other communication connections 24, and a system bus 32 used to facilitate communications between the components of the device 12.

Depending on the configuration and type of user device 12, memory 22 may be volatile (such as RAM), non-volatile (such as ROM, flash memory, etc.) or some combination of the two. Additionally, the device 12 may also have additional features/functionality. For example, the device 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the device 12. The storage 30 in one embodiment may be a mass-storage device with associated computer-readable media providing non-volatile storage for the device 12. Although the description of computer-readable media as illustrated in this example may refer to a mass storage device, such as a hard disk or CD-ROM drive, it will be appreciated by those skilled in the art that the computer-readable media may be any available media that can be accessed by the device 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by device 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of communication media.

The device 12 may also contain communications connection(s) 24 that allow the computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the device 12 may operate in a networked environment as illustrated in FIG. 1 using logical connections to remote computers through a network. The device 12 may connect to the network 14 of FIG. 1 through a network interface unit 26 connected to bus 32. The network interface unit 26 may also be utilized in connection with other types of networks and/or remote systems and components.

In one embodiment, the device 12 may be tablet computer. As known in the art, a tablet computer may be characterized as a computer shaped in the form of a notebook or a slate with the capabilities of being written on through the use of digitizing tablet technology or a touch screen. A user can use a stylus or electronic pen and operate the computer without having to have a keyboard or mouse. An electronic representation of the stylus or pen movements, pressure, and other characteristics may be referred to as digital or electronic ink. Ink resulting from an elementary pen movement may be referred to as a stroke. One or more strokes in a sequence constitute a trace defined as a complete pen-down movement bounded by two pen-up movements. A sequence of traces may comprise other larger recognized units such as characters or words. A gesture may be defined as a collection of ink traces that indicate an action to be performed. An ink annotation may be defined as a handwritten note made, for example, using the electronic pen on a display of a tablet computer. In connection with techniques that will be described herein, ink annotations made on a displayed image may be represented and stored as image metadata in the same image file as other image data representing the original displayed image. The ink annotations and image data are stored in the same image file while also preserving the original image data. Using the techniques herein, the ink annotations may be interactively entered and stored as part of the metadata of the image file rather than as the image data. Applications which include functionality for utilizing digital ink may load the image file with image data and the ink annotations stored as metadata. The functionality may include allowing a user to view, edit and perform other operations on just the ink annotations alone, the image data alone, or the combination of the image data and the ink annotations. Using the techniques herein, the digital ink of the ink annotations may be characterized as a separate layer over the image data and the image data may be viewed with or without the ink annotations.

One or more program modules and/or data files may be included in storage 30. During operation of the device 12, one or more of these elements included in the storage 30 may also reside in a portion of memory 22, such as, for example, RAM for controlling the operation of the user computer 12. The example of FIG. 2 illustrates various components including an operating system 40, one or more application programs 46, and other components, inputs, and/or outputs 48.

In one embodiment, the application program 46 may be an application used in connection with image files of one or more types. The application program 46 may be able to process digital ink annotations for use in connection with the one or more image file types. For example, the application program may be a photo editor which loads image files, such as JPEG files. The application program may allow a user to interactively enter digital ink annotations on a displayed image such as using a pen,or stylus or other interactive input device. The application program may allow the user to save the ink annotations as part of the image file but without modifying the original image data using the techniques herein.

The operating system 40 may be any one of a variety of commercially available or proprietary operating systems. In one embodiment, the operating system 40 may be the Microsoft® Windows XP™ operating system. The operating system 40, for example, may be loaded into memory in connection with controlling operation of the device 12. One or more application programs 46 may execute in the device 12 in connection with performing user tasks and operations.

In one embodiment, the device 12 may be a tablet computer as described above and may operate in a standalone mode in connection with performing the techniques herein. In other words, the components used in connection with performing the techniques herein may all reside and execute on the device 12 in one arrangement. However, the foregoing should not be construed as a limitation of the techniques herein which, as will be appreciated by those skilled in the art, may be utilized with a wide variety of devices and arrangements capable of performing the processing described herein.

It should be noted that an embodiment of the server 15 may include hardware components similar to those illustrated in connection with FIG. 2. The server 15 may also include server-side software application components for performing various tasks as may be used in an embodiment.

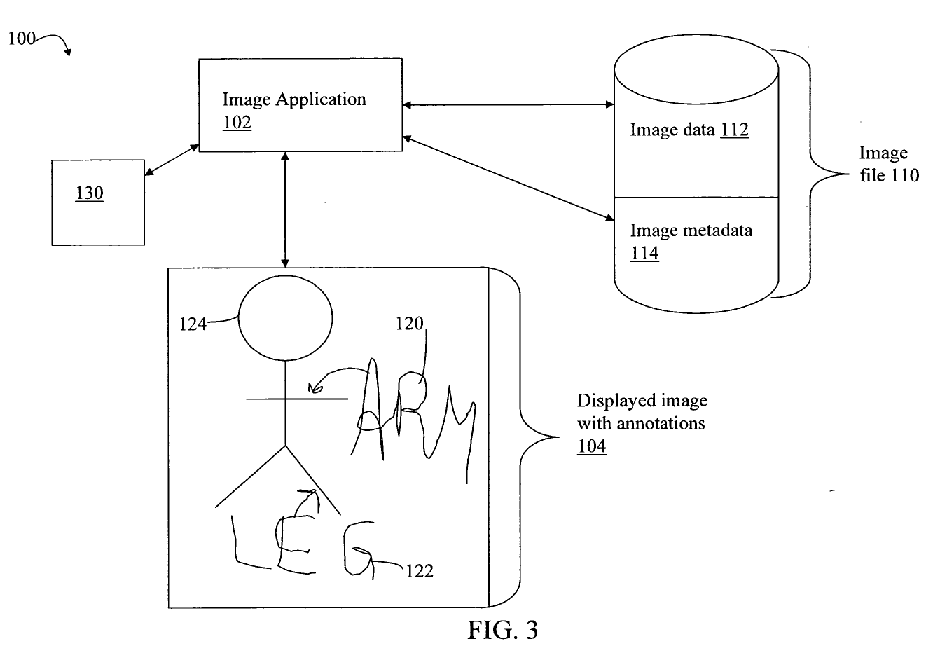

Referring now to FIG. 3, shown is a block diagram illustrating the data flow between various components that may be included in an embodiment utilizing the techniques herein. The example 100 includes an image application 102, a displayed image with annotations 104, an image file 110, and one or more other components including code used by the application 102. The image application 102 may be, for example, an application program 46 such as the photo editor described in connection with FIG. 2 capable of processing digital ink annotations.

The image application 102 may load an image file 110, such as a JPEG, GIF, TIF or other image file, for use with the application 102. As an example, the user may load an image file of a photograph taken with a digital camera. The user may wish to annotate the image file, such as by making digital ink annotations thereon, of particular items in the photo. An ink annotation may be the result of a user drawing on a screen of a tablet computer, digitizer pad, or other device for handwriting or drawing over a displayed image. The digital ink annotations may be formed from one or more ink strokes which are captured and represented in a format which is then stored in the image metadata portion 114 of the image file 110. The image data 112 representing the original displayed image, such as the photograph, may be stored as image data portion 112. The image application may invoke one or more other components 130, such as operating system routines, in connection with performing the techniques herein. It should be noted that an embodiment may alternatively include an application 102 which is capable of performing processing as described herein without utilizing the other components 130.

In connection with the techniques herein, the ink annotations may be stored as part of the image file 110. In one embodiment, the image file may include image data 112 and metadata 114. The ink annotations may be persisted as metadata 114 separate from the image data 112 included in the image file 110. The particular location of the metadata for each image file may vary with the file type.

It should be noted that the metadata may be in accordance with any one of a variety of different formats and representations. For example, XMP (Extensible Metadata Platform) by Adobe Systems, Incorporated, or EXIF (Exchangeable Image File Format) may be used to embed metadata in any one of a variety of different types of image files. In accordance with XMP or other specification, the specification may indicate how the metadata items are represented or encoded in the metadata portion of different file types. It will be appreciated by those skilled in the art that XMP and EXIF are only examples of a metadata model or format that can be used to describe and store metadata items in a uniform way for use in accordance with the techniques herein.

The displayed image with annotations 104 is an exemplary representation of a displayed image 124 represented by image data 112. The ink annotations 120 and 122 may be used to annotate portions of the displayed image 124. In one embodiment, the annotations may be interactively entered at arbitrary locations over the displayed image area. The image application 102 may persist the image data for the displayed image 124 in the image data portion 112. Additionally, the application 102 may persist the ink annotations 120 and 122 in a form included in the image metadata 114.

In one embodiment, the ink annotations stored in the image file metadata portion 114 may be included in the header of the image file. However, the location of the metadata within an image file as well as the particular location within the metadata portion at which data representing the ink annotations is stored may vary with each image file type. When the ink annotations are represented as metadata separate from the image data of the image file, the original image data may be preserved if it is otherwise unmodified. Furthermore, the annotations may be modified or otherwise operated upon independently of the image data. For example, using the techniques herein, an application 102 which provides operations using ink annotations may allow a user to view, edit and perform other processing on the ink annotations separately and independently of the image data without having a separate file for the ink annotations. The original image data may also be preserved so that a user may reuse the original image data separately from the ink annotations. Any portion of the ink annotations may be erased or removed from the original displayed image without saving a copy of the image prior to making annotations thereon. In other words, the image data may be operated upon independently of the ink annotations. Based on the foregoing, the ink annotations may be characterized in one aspect as a separate, modifiable layer over an image in which the image may be viewed with or without the ink annotations being applied.

An example of an image application 102 may be a photograph or picture editor including functionality as described herein which stores the ink annotations as part of the image metadata while preserving the image data. When the user performs operations for modifying the image data such as, for example, cropping, color correction, rotations, and the like, the original image data may be modified and accordingly persisted in the modified form. When the user adds or modifies the digital ink, rather than modify the image data, the image metadata representing the ink annotations is accordingly modified to reflect any changes with respect to the ink annotations. The separation of data representing the annotations from the image data allows for preservation of the original image if operations are performed which only modify the ink annotations. Using the techniques herein, the original image data may be displayed for viewing and operated upon without the ink annotations layered thereon. Furthermore, the ink annotations may also be displayed and otherwise operated upon (e.g., copy, cut, paste, select, modified, and the like) independently of the image data.

What will now be described is an exemplary embodiment in which the techniques herein may be performed using the application programming interfaces (APIs) of the InkPicture class included in the Microsoft®Windows XP™ Tablet PC Edition Platform Software Development Kit. The foregoing APIs may be used to add digital ink on top of an image being displayed and to represent the ink annotations in memory in a format such as the ink serialization format (ISF) by Microsoft® Corporation. The annotations encoded in the ISF form may then be persisted as metadata of the image file. The image application 102 may be implemented using the .NET™ Framework and associated image file type APIs for one or more image file types (e.g., JPEG, GIF, TIFF, and the like) for storing the image data and associated metadata. The foregoing are examples of different APIs, development environments, and formats that may be utilized in an embodiment and should not be construed as a limitation of the techniques herein which have broader applicability and use.

In one embodiment, the user may load an image file, such as a JPEG image file for use with an image editor application. The user may display the image and interactively make ink stokes forming annotations thereon using an input device such as, for example, a digital pen or stylus. To the user, it appears as if the displayed image is being modified and that the user is writing on the image. However, using the techniques herein, the actual image data of the displayed image is not modified in accordance with the ink annotations made. Rather, the strokes forming the ink annotations may be captured and persisted as metadata of the image file rather than being incorporated into the image data, as with existing techniques. The ink annotations may be handled as a separate layer. In one embodiment the digital ink annotations may be converted to a representation having a format, such as ISF available from Microsoft® Corporation for storing digital ink. An embodiment may represent the ink annotations for inclusion in the image file metadata portion using any one of a variety of different formats and representations other than ISF. The ink annotations as represented in accordance with the ISF may be persisted as metadata of the image file. In one embodiment, an API, such as those included in .NET™ Framework, may be used to store the ISF representation of the ink annotations in the metadata portion of the image file.

In one embodiment, the ink annotations may be automatically converted to the ISF, or another representation used when persisting the ink annotations in the metadata, as the interactive modifications to the ink annotations occur. The ISF representation of the ink annotations may be stored in memory. At a later point in time, such as in response to a command to save a displayed image, the ISF representation of the ink annotations may be persisted along with the image data to the image file of the displayed image. In another embodiment, the ink annotations may be automatically converted to the ISF or other form for inclusion in the metadata as part of processing when saving the image file. In other words, in the latter embodiment, the conversion of the annotations from digital ink to a form used when persisting the image file is performed automatically as part of processing to save the image file to a data storage device rather than in response to interactively modifying the existing annotations of a displayed image.

In connection with retrieving data from an image file having data stored therein in accordance with the techniques herein, the image data and metadata portions may be read from the image file. The image may be displayed in accordance with the image data. The portion of the metadata including the representation of the ink annotations in the ISF form may be read and then converted to digital ink which is then displayed on the image.

Once the image and ink annotations are displayed, the user may perform one or more operations to the image data (e.g., cropping, rotating, color correction, and the like), and/or the ink annotations (e.g., add new annotations, remove existing annotations, and the like). The modified form of the image data and the ink annotations may be persisted to the image file as described herein with a representation of the ink annotations being stored in the image file metadata portion.

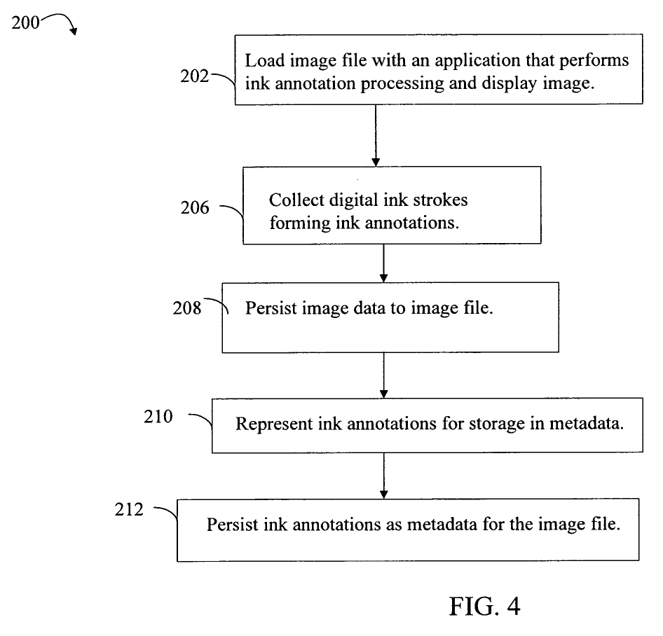

What will now be described in connection with FIGS. 4, 5 and 6 are processing steps that may be performed in an embodiment using the techniques herein. The flowcharts summarize processing just described.

Referring now to FIG. 4, shown is a flowchart of processing steps that may be performed in an embodiment in connection with persisting a representation of the ink annotations in accordance with the techniques herein.

At step 202, an image file may be loaded for use in connection with an application that performs ink annotation processing. The image file may include image data which is displayed on an output device. At step 206, a user may make digital ink strokes on the displayed image, such as using a pen or stylus or other interactive input means. The ink strokes may form the ink annotations which are collected. After the user is done annotating the displayed image, the image data may be persisted to the image file in step 208. At step 210, the ink annotations may be represented in a format for storage in the metadata portion of the image file. As described herein, step 210 may be performed at various times in an embodiment. In one embodiment, the conversion of digital ink annotations may be performed as interactive ink annotation modifications occur. In another embodiment, step 210 may be performed as part of processing to save or update the image file. At step 212, the ink annotations, as represented in the ISF or other format, are persisted to the metadata portion of the image file.

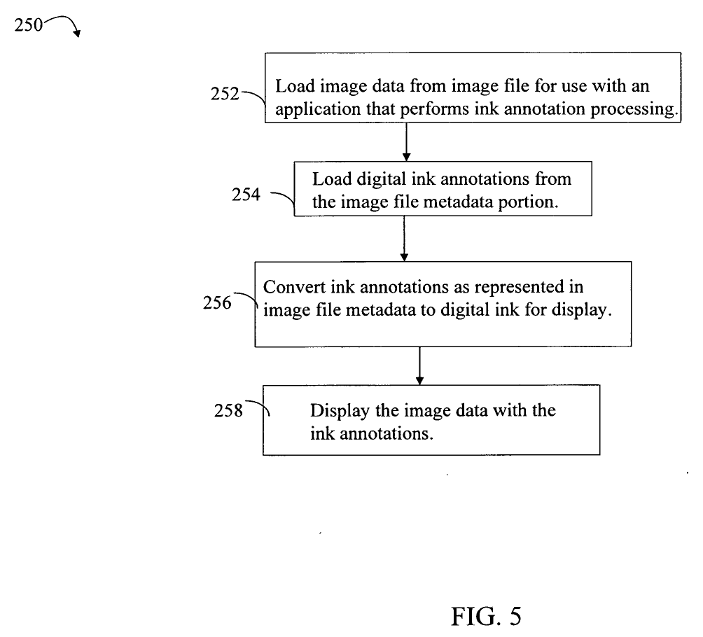

Referring now to FIG. 5, shown is a flowchart of processing steps that may be performed in an embodiment in connection with retrieving an image file having data stored therein in accordance with the techniques herein. At step 252, the image data may be loaded from the image file for use with an application that performs ink annotation processing. At step 254, the digital ink annotations are loaded from the image file metadata portion. At step 256, the ink annotations as represented in the image file metadata are converted to digital ink for display. At step 258, the image data and the ink annotations may be displayed.

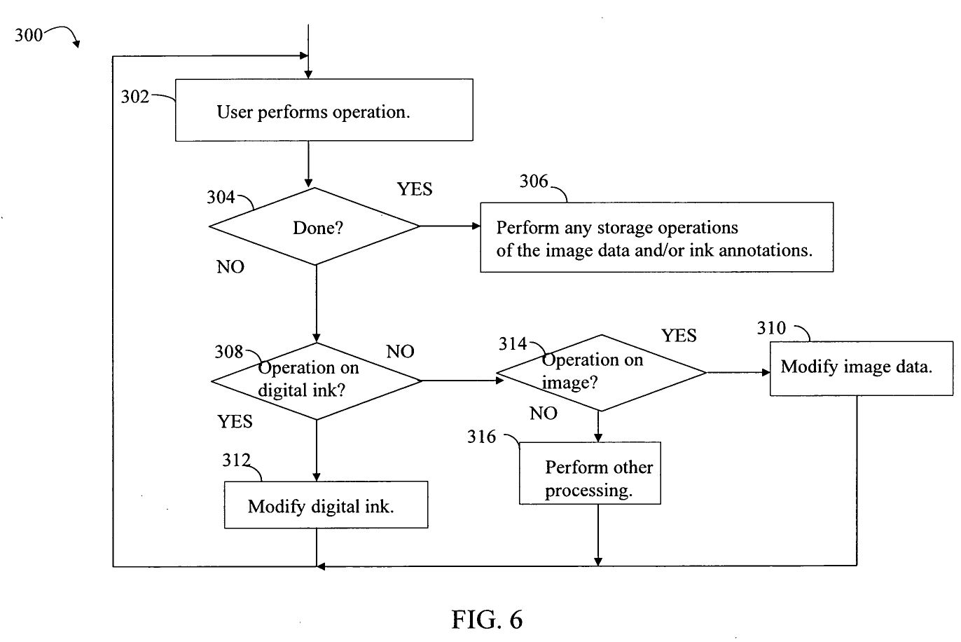

Referring now to FIG. 6, shown is a flowchart of processing steps that may be performed in connection with a displayed image and/or ink annotations using the techniques herein. Processing of flowchart 300 presumes that a display area is populated with an image and any associated annotations and the user performs one or more operations in connection with the display area. In step 302, the user performs an operation. The particular operation may be in accordance with the functionality provided by the executing application utilizing the displayed image. The operation may cause a modification to the image data such as, for example, in connection with cropping, color correction, and the like. The operation may cause a modification to the digital ink such as, for example, by adding new annotations, removing an existing annotation, and the like. At step 304, a determination is made as whether the user is done with the currently loaded image. If so, control proceeds to step 306 to perform any storage operations of the image data and/or ink annotations in accordance with the techniques herein. For example, an embodiment may automatically store any modification to the image data and/or metadata portions in accordance with the techniques herein when a user closes an image file, loads a new image file, and the like. If step 304 evaluates to no, control proceeds to step 308 to determine if the operation utilizes digital ink. If so, control proceeds to step 312 to accordingly modify the digital ink. Control proceeds from step 312 to step 302 with the next user operation. If step 308 evaluates to no, then control proceeds to step 314 where it is determined if the operation is performed on the image. If so, control proceeds to step 310 to accordingly modify the image data. From step 310, control proceeds to step 302. If step 314 evaluates to no, the operation involves other processing and control proceeds to step 316. From step 316, control proceeds to step 302.

It should be noted that although the flowchart of 300 may describe processing in an application providing operations which result in modification of image data or the digital ink thereon, an application may also include operations in which both of the foregoing may be modified.

An embodiment may also include one or more APIs so that a developer may utilize the functionality described herein.

An embodiment may include APIs which operate on image files. An embodiment may include an API for use when reading or loading an image file. The API may include a parameter identifying a location (e.g., program variable corresponding to a memory location) at which to store the representation of the ink annotations retrieved from the image file metadata portion. The API may handle processing in accordance with the type and format of the image file by extracting the representation of the ink annotations from the image file and returning the representation as the parameter. In the foregoing, an API may be used to read data from the image file storage location into memory and also extract the metadata for the ink annotations from the image file.

An embodiment may include an API for storing data to an image file. The API may include a parameter identifying a location from which a representation of ink annotations are retrieved and stored in the image file metadata portion. The API may handle processing of storing the ink annotations in the appropriate portion location of the image file in accordance with the type and format of the image file. In the foregoing, an API may be used to persist data to the image file and also map the representation of the ink annotations to the correct location in the image file.

Rather than operate on image files, an embodiment may include one or more APIs which operate on an object identifying a portion of memory holding the image file data including the image data and the metadata. A first API may be used to store the representation of the ink annotations, along with possibly other data, to the appropriate in-memory location in the object containing the image file metadata. Subsequently, another API may be used to write the in-memory copy of the image file data as stored in the object to the image file. In the foregoing, a first API may be used to map the metadata of the ink annotations to the appropriate in-memory location and a second API may persist the in-memory copy of the image file data to storage.

An embodiment may include an API for converting from a source format to a target format including conversion or mapping of any metadata from the source to target format. The source and target formats may correspond to different types and formats of image files. The source format and/or target format may be associated with memory locations or image files. As an example, the API may convert data stored in memory having a first format and including ink annotations as metadata to a second format also including ink annotations as metadata. The API may then perform processing to store the data as an image file in accordance with the second format. For example, the API may be used to convert from a JPEG format having ink annotations stored in the metadata portion to another format also having a metadata portion in a different location. If the source and target formats are both associated with memory locations, a first API may be used to initially retrieve the image file data from a source image file and load the image file data into a source memory location. The API for converting from the source to the target format may be used to convert the image file data from the source memory location having a first format to a second format stored at a target memory location. A second API may be used to store the data from the target memory location to an image file in the second format.

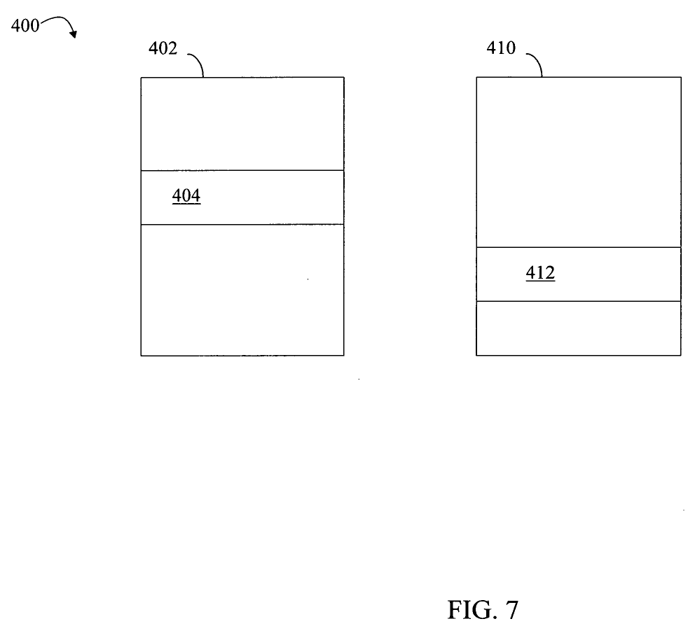

Referring now to FIG. 7, shown is an example representation of a source 402 and a target 410. As described above, the source 402 may represent a memory location or image file having a first format. Portion 404 may correspond to the metadata portion representing the ink annotations in the source. Target 410 may represent a memory location or image file having a second format. Portion 412 may correspond to the metadata portion representing the ink annotations in the target. The API described above for converting from a source format to a target format may be invoked to perform processing for retrieving data from 402 and storing the data in a corresponding location in accordance with the format of 410. The API may perform processing, for example, for storing data from 404 in portion 412.

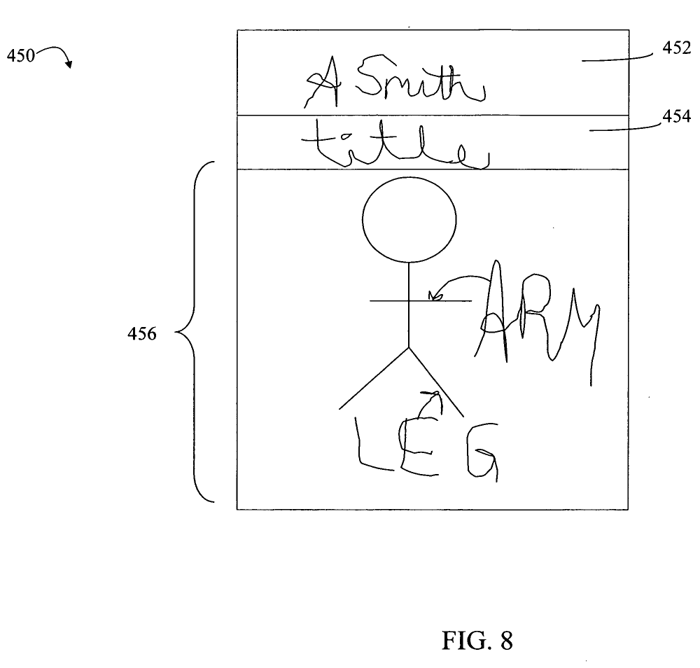

Referring now to FIG. 8, shown is an example illustrating an interface used to display an image used in connection with the techniques herein. The example 450 includes a displayed image in portion 456 and two other portion 402 and 404. In an embodiment using the techniques herein, annotations interactively entered into one or more designated portions of the user interface may be processed using the techniques herein. In the example 450, a representation of annotations interactively entered in portion 456 may be stored as metadata in the image file of the displayed image. However, annotations made in other portions 452 and 454 may not be processed in accordance with techniques herein and are not represented as metadata of the image file.

As described herein, the ink annotations may be represented and stored as metadata. The techniques herein may also be used with storing a representation of other information about the image data as metadata. For example, an embodiment may persist a representation of one or more image metrics as metadata alone or in combination with the ink annotations. In connection with the exemplary embodiment described above with ink annotations, additional information about the image data may also be encoded in the ISF stream stored as metadata. The additional information may include one or more characteristics or attributes related to the displayed image. As an example, a CRC(cyclic redundancy check) value and current image size/dimensions may also be encoded in the ISF stream and stored as metadata. The CRC and image dimensions may be useful in connection with subsequent uses of the ink annotations also included in the metadata. When the image file is reloaded, the stored CRC value in the ISF may be compared to the CRC for the image data to determine if the image data has been modified since the ink annotations were last saved. If the CRC values match, indicating that the image has not been resized, then the ink annotations may be used as included in the ISF stream. If there has been a change as indicated by the different CRC values, then the image data has been modified since the ink annotations were stored in the ISF metadata. The image may have been resized since the ink annotations were stored to the image file metadata. The previously stored dimensions included as metadata may be used in connection with correctly resizing or scaling the stored ink annotations, also stored as metadata, in accordance with the current image dimensions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for storing data about a displayed image comprising:
receiving image data corresponding to the displayed image;
receiving one or more ink annotations associated with the displayed image;
storing the image data in a first portion of an image file; and
storing a representation of the ink annotations in a second portion of the image file.

2. The method of claim 1, wherein the second portion of the image file is a metadata portion of the image file.

3. The method of claim 2, wherein the metadata is included in the header of the image file.

4. The method of claim 1, further comprising:
performing an operation in connection with the displayed image.

5. The method of claim 4, wherein the operation causes a modification to the image data.

6. The method of claim 4, wherein the operation causes a modification to the metadata portion.

7. The method of claim 6, wherein the operation includes making an ink annotation on the displayed image or modifying an existing ink annotation on the displayed image.

8. The method of claim 1, further comprising:
converting the one or more ink annotations from a first form used in connection with displaying the one or more ink annotations to a second form, the representation of the ink annotations in the second portion of the image file having the second form.

9. A computer readable medium comprising code stored thereon for performing operations on a displayed image, the computer readable medium comprising code for:
making an ink annotation on the displayed image;
performing an operation using at least one of the ink annotation and image data of the displayed image;
modifying at least one of the image data and the ink annotation in accordance with the operation;
storing a representation of the ink annotation and one or more image metrics in a metadata portion of an image file for the displayed image; and
storing the image data in an image data portion of the image file for the displayed image.

10. The computer readable medium of claim 9, wherein the operation includes making another ink annotation in the displayed image and the metadata portion of the image file is accordingly updated.

11. The computer readable medium of claim 9, wherein the operation includes modifying the displayed image resulting in a modification to the image data.

12. The computer readable medium of claim 9, wherein the operation includes removing the ink annotation.

13. A method for loading an image file comprising:
reading image data from a first portion of the image file;
reading metadata including a representation of ink annotations stored therein from a second portion of the image file;
converting the representation of the ink annotations to digital ink; and
displaying an image with the ink annotations in accordance with the first portion and second portion from the image file.

14. The method of claim 13, further comprising:
performing an operation causing the image to be displayed without the ink annotations.

15. The method of claim 13, further comprising:
performing an operation causing the ink annotations to be displayed without the image.

16. The method of claim 13, wherein the metadata is included in a header of the image file and the metadata is stored in accordance with a specification indicating a format for the metadata.

17. The method of claim 13, wherein the image data and metadata are read from an image file having a first format to a first memory location, and the method further comprising:
converting data stored at the first memory location having the first format to a second format stored at a second memory location, said first format including a first metadata portion at a first location at which the representation of the ink annotations is stored and the second format including a second metadata portion at a second location at which the representation of the ink annotations is stored.

18. The method of claim 17, wherein said converting data stored at the first memory location is performed by invoking an application programming interface.

19. The method of claim 13, wherein an application programming interface is invoked to read data including the metadata and the image data from the image file in accordance with the particular format of the image file.

20. The method of claim 17, further comprising:
invoking an application programming interface to persist data from the second memory location.
